(19) United States
(12) Patent Application Publication
(10) Pub. No.: US 2005/0135387 A1
(43) Pub. Date: Jun. 23, 2005

(54) Modular gateway

(75) Inventors: Tom Rychener, Phoenix, AZ (US); Ken Krisik, Avondale, AZ (US)

Correspondence Address: Squire, Sanders & Dempsey L.L.P.;Two Renaissance Square, Suite 2700, 40 North Central Avenue, Phoenix, AZ, 85004-4498, US

(73) Assignee: International Internet Telecom, Inc.

(21) Appl. No.: 10/741,260

(22) Filed: Dec. 19, 2003

(51) Int. Cl. H04L 12/56

(52) U.S. Cl. 370/401

(57) ABSTRACT

A gateway includes a plurality of gateway modules, coupled together for servicing communication among all of the ports coupled to any of the modules. The number of ports serviced may be increased by adding a gateway module with a minimum of physical and operational configuration changes to the existing gateway modules of the gateway. A gateway module is particularly suitable for use in a scalable gateway. The gateway module includes: a plurality of network ports, a commissioned communication engine, a reserve communication engine, a switchover circuit, and a scaling circuit. In one implementation protocol conversion by the gateway module facilitates voice over Internet (VOIP) communication including network ports coupled to T1/E1 interfaces of plain old telephone systems (POTS) switched telephone networks.

### FIELD OF THE INVENTION

Embodiments of the present invention relate to systems for routing and protocol translation between disparate networks such as telephony and the Internet.

### BACKGROUND OF THE INVENTION

A conventional packet-based multimedia communication system supports communication of data between computer systems (e.g., file transfers), client-server computer communication (e.g., as for application service providers), audio communication (e.g., music delivery), voice communication (e.g., telephony), and video communication (e.g., video conferencing). In one conventional specification ITU H.323 defined by the International Telecommunications Union end points (also called terminals) communicate between each other by signals that are processed in gateways. A gateway serves as a protocol converter between networks that have native H.323 capability and those that do not. Newer endpoints for voice over Internet Protocol (VOIP) may have computer communication network capability (e.g., coupled to a local area network that uses IEEE 802.3 (ethernet)). Older endpoints for voice communication may have plain old telephone system (POTS) capability. Conventional voice telecommunication services use gateways to facilitate communication between the newer and older endpoints.

It is highly desirable to provide a gateway having high reliability, relatively low cost, relatively high quality of service (QoS), and expansion capability to service an increasing number of simultaneous and independent voice communications (also referred to as “calls”). Without features of the present invention, the market demand for voice communication will continue to be fraught with relatively low quality service at prices the market is willing to pay per call for VoIP technology.

### SUMMARY OF THE INVENTION

A gateway, according to various aspects of the present invention, includes a plurality of gateway modules, coupled together for servicing communication among all of the ports coupled to any of the modules. The number of ports serviced may be increased by adding a gateway module with a minimum of physical and operational configuration changes to the existing gateway modules of the gateway.

A gateway module according to various aspects of the present invention is particularly suitable for use in a scalable gateway coupled to a network. A gateway module for use in a scalable gateway includes a commissioned communication engine, a reserve communication engine, a network interface circuit, and a scaling circuit.

Each communication engine facilitates voice communication between any two or more network ports of a plurality of network ports. Network ports include a first set operative in accordance with a first (e.g., frame-based) protocol and a second set operative in accordance with a second (e.g., packet-based) protocol different from the first. Each engine includes for each port an input queue that receives network traffic and an output queue. Each engine enqueues into each output queue messages prepared in accordance with dequeueing from the respective input queue. Each engine dequeues from each output queue in accordance with the respective protocol.

The network interface circuit couples data dequeued from each output queue of the commissioned communication engine to the provided network and, in response to either communication engine detecting an exceptional condition, decommissions the formerly commissioned communication engine and commissions the formerly reserve communication engine. Decommissioning includes disabling the coupling to the provided network of data dequeued from the output queues of the formerly commissioned communication engine without disabling dequeueing from each output queue of the decommissioned engine.

The scaling circuit determines whether the gateway module is a provider of expansion signals and, if so, each communication engine and an interface of the gateway module are coupled to the scaling circuit to receive the expansion signals as provided by the scaling circuit. Otherwise, each communication engine receives expansion signals as provided by a provided other gateway module. The expansion signals facilitate an expansion of the plurality of network ports to include network ports of the provided other gateway module.

By effecting decommissioning without disabling enqueueing messages to respective output queues, communication engines support reliable failover by operating concurrently without the complexity and potential unreliability of synchronization circuits. Further, failover of one engine to another as discussed above does not disrupt operation of application programs at the communication engine level or application programs at the gateway (e.g., supervisor) level.

### BRIEF DESCRIPTION OF THE DRAWING

Embodiments of the present invention will now be further described with reference to the drawing, wherein like designations denote like elements, and:

FIG. 1 is a functional block diagram of a network having a gateway that services communication between formerly distinct networks that each have a unique protocol;

FIG. 2 is a functional block diagram of a gateway module of the gateway of FIG. 1;

FIG. 3 is a functional block diagram of a communication engine of the gateway module of FIG. 2; and

FIG. 4 is a data flow diagram of processes performed by each communication engine of the gateway module of FIG. 2.

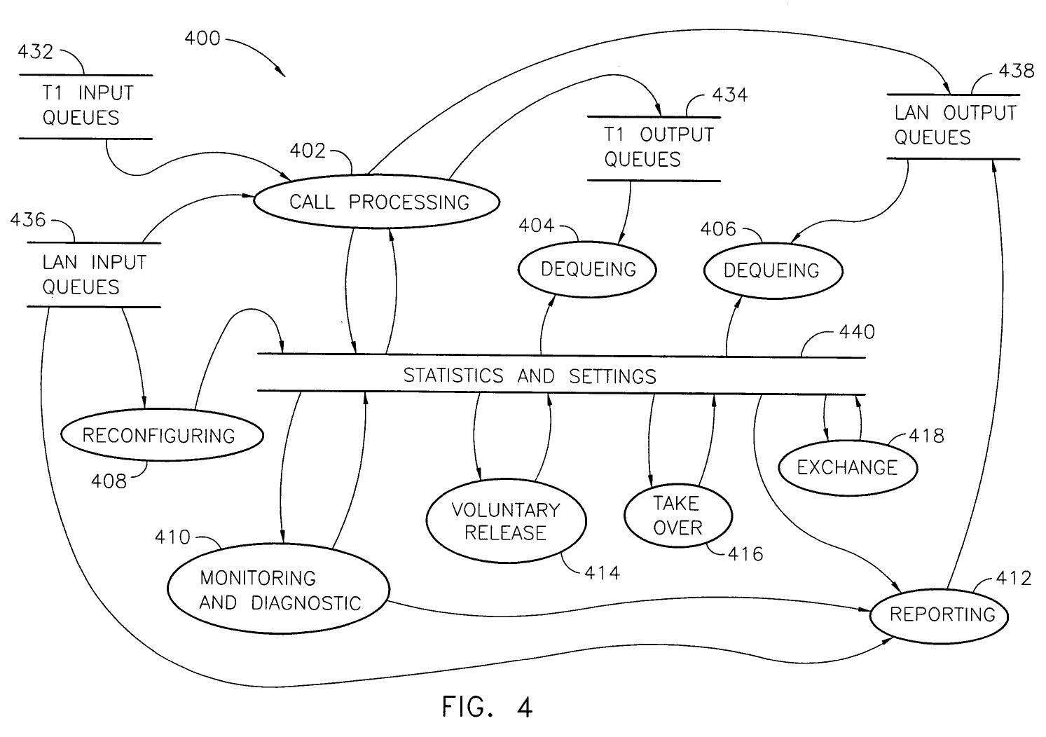

### DETAILED DESCRIPTION OF THE PREFERRED EMBODIMENTS

A gateway, according to various aspects of the present invention, provides communication between any number of endpoints that are coupled to one network and any number of other endpoints that are coupled to another network. The networks may be logically or physically separate except for operation of the gateway. The networks may be incompatible due to the use of different protocols. After installation of the gateway, one network is formed among all endpoints. Communication via the gateway allows the endpoints to operate from time to time as sources and/or sinks of data used for information display, interprocess communication (e.g., as provided by an application service provider), audio and/or video reproduction, and telephony. A gateway may be installed to join any number of formerly distinct networks, with protocol conversions appropriate to each network.

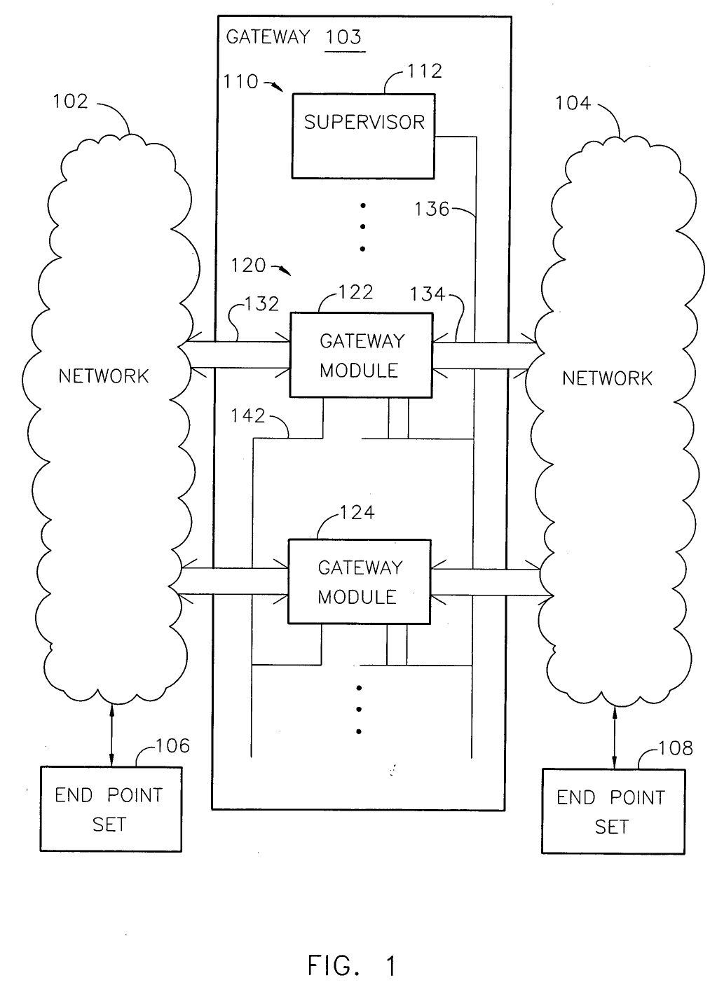

For example, network 100 of FIG. 1 provides communication from endpoint set 106 to endpoint set 108 and vice versa. Endpoint set 106 is coupled to network 102 that supports any number of endpoints for communication therebetween. Endpoint set 108 is coupled to network 104 that supports any number of endpoints for communication therebetween. Gateway 103 is coupled to network 102 (i.e., is a member of network 102 ) and communicates according to the protocol(s) of network 102. Gateway 103 is also coupled to network 104 (i.e., is a member of network 104 ) and communicates according to the protocol(s) of network 104. After installation of gateway 103, endpoint sets 106 and 108 communicate with network 100 which includes network 102, gateway 103, and network 104.

An endpoint set includes any device capable of participating as a member of a network for receiving and/or sending information to another endpoint of the network. An endpoint set may include general purpose circuitry and software for communicating information for any purpose discussed above; or, special purpose circuitry and/or software for communicating information for any limited number of purposes or one purpose (e.g., only audio telephony). Consequently, special purpose endpoints (e.g., TV sets, cellular telephones, POTS telephone sets) may be members of either network for which gateway 103 facilitates intercommunication.

Gateway 103 may provide numerous independent connections to either network 102 and 104. Adding connections may improve reliability due to increased communication capacity and alternative connections for failover. Gateway 103 includes a modular hardware system design or architecture; and a modular software system design or architecture. These architectures facilitate scaling gateway 103 for network applications of different capacity requirements.

The hardware architecture of gateway 103 includes a set 110 of one or more supervisors 112 and a set 120 of one or more gateway modules 122, 124. Each gateway module (122) is coupled to a supervisor (112) by a bus 136. Bus 136 provides two or more connections to each gateway module for failure detection, increased capacity, and failover. Each gateway module is also coupled to network 102 via any suitable number of connections 132, to network 104 via any suitable number of connections 134, and to other gateway modules via bus 142. Each network connection 132, 134 (also called a port) may conform to any mix of conventional network protocols including protocols at any number of levels of the well known Open System International communication model. Bus 136 and 142 comprise an expansion port. Bus 142, according to various aspects of the present invention, provides synchronization between gateway modules and provides communication so that a communication link for a particular communication purpose or session may include any number of ports (typically two ports) each respectively of any gateway module of the set 120.

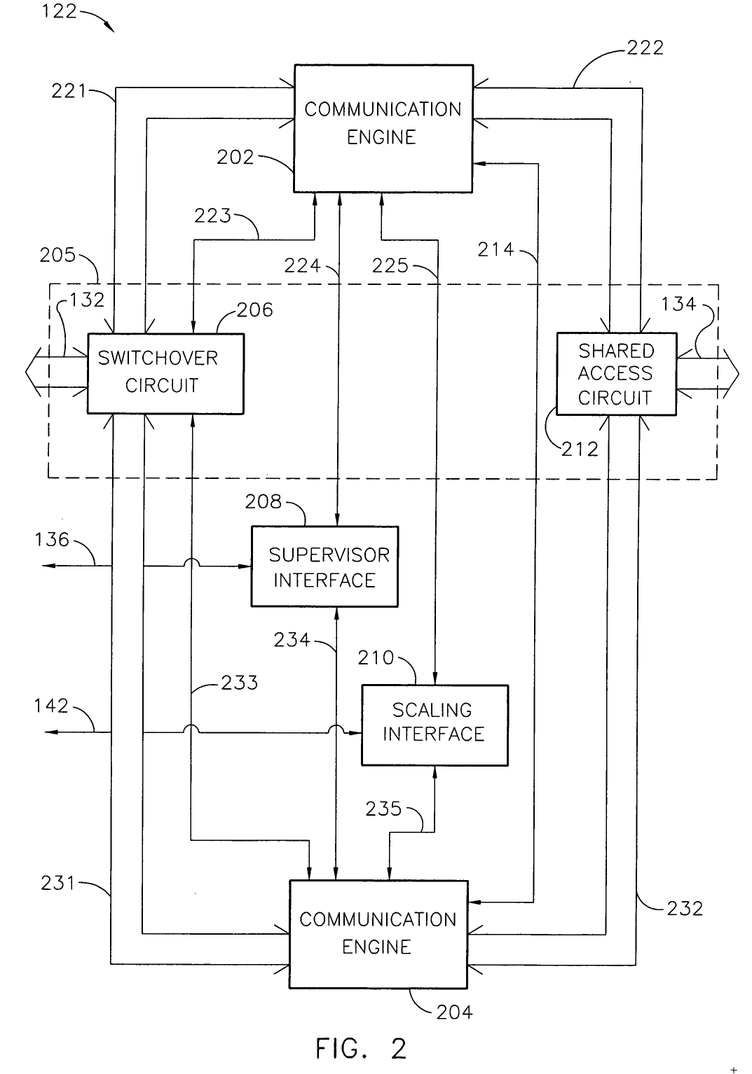

A gateway module reliably supports communication simultaneously through each of its ports. Data entering the gateway module from any of its port or expansion port may exit the module from the same or any other of its ports or the expansion port. For example, a port of gateway module 122 on the network 104 side may be part of a link to another port of gateway module 122 on the network 104 side, another port of gateway module 122 on the network 102 side, or any port of gateway module 124. To avoid reliance on any single point of failure, each gateway module includes at least two communication engines running concurrently. For example, gateway module 122 of FIG. 2 includes communication engines 202 and 204, network interface 205, and scaling interface 210. Bus 214 couples communication engines to facilitate concurrent operation.

Network interface 205 includes switchover circuit 206 and shared access circuit 212. Identical buses 221 and 231 respectively provide each communication engine with data communication with switchover circuit 205, while buses 223 and 233 respectively provide control capability and status of switchover circuit 205. Identical buses 222 and 232 respectively provide each communication engine with data communication, control capability, and status of shared access circuit 212. In one implementation a first bus replaces buses 221 and 222; and a second bus replaces buses 231 and 232 for simpler interfacing to communication engines.

In operation, each communication engine concurrently performs the same suite of communication software on all received data (e.g., every packet and every frame). Concurrence is distinguished from synchronization (e.g., lock step or microsynchronization) in that concurrent processing does not necessarily produce respective results virtually simultaneously. Because received data is generally dequeued from input queues and results are generally enqueued to output queues, concurrent processing assures that output queues are typically not different by more than a small number of enqueueing operations. For example, an output queue serviced by one engine may be some relatively small number (e.g. up to three) queueing operations behind or ahead of the corresponding output queue of another engine of the module.

By maintaining queues with relatively similar contents, commissioning the reserve communication engine can result in failure to transmit a result due to a task or enqueueing operation not yet completed by the concurrently operating reserve engine. Nevertheless, a suitable quality of service, accuracy of monitoring, and completeness of application programs is accomplished.

The suite of communication software generally includes an operating system; lower level drivers, services, and application programs; and upper level application programs. Lower level software may include gateway module configuration management, communication message parsing and performance of requests indicated by messages (e.g., call setup, network discovery, routing table development and sharing), processes for routing messages (e.g., parsing, formatting replies, reformatting headers and payloads, implementing QoS services), and processes for protocol conversion (e.g., POTS protocols to/from LAN protocols). Upper level software may include processes for analyzing network utilization, billing for utilization, assuring reliable gateway and network operations (e.g., failover, firewalls), and providing services (e.g., data archiving, message multicasting, message broadcasting, and cooperation among gateway modules). In combination lower and upper level software may provide telephone services such as 3-way call; notice of call waiting, hold, connect, and continue; notice of caller's identification; call forwarding including conventional “follow me” services; group pickup (e.g., for an office environment); and call blocking based on caller's identification or group. Lower and upper level software in one implementation suitably performs all functions using conventional techniques for efficient required or suggested operations consistent with the following specifications: PRI, SPANS, RDT, PBX, POSIX, TR 303, ISDN, MFR1, MFR2, E&M, H323, SIP, RTCP, RTP, SMTP, TCP/IP, H.100, IEEE802.3, T1/E1, TDM, and PCM.

Gateway supervisor 112 cooperates with each supervisor interface 208 to provide supervisory functions. Supervisory functions control the configuration of gateway modules for reliable gateway operations. In one implementation, supervisor 112 and supervisor interface 208 cooperate to coordinate billing for gateway and network utilization based on services requested or used in processing messages of types identifiable to a responsible party to be billed; redirection of messages to alternate paths (e.g., to maintain QoS); redirection of messages to alternate end points (e.g., call forwarding, voicemail, alternate IP address, alternate telco phone number); detection of degrading or degraded service and commissioning of alternate communication resources; monitoring of operations (e.g., traffic monitoring, journaling of administrative actions); performing maintenance testing; and supporting a user inter for administration. In one implementation a control channel carries signals conveying commands and status among gateway modules and supervisor 112. The control channel may include the expansion port (136, 142) and conventional control message traffic on each network 102, 104 to other network nodes. Control message traffic may include messages for decommissioning and commissioning gateway modules and communication engines of gateway modules.

A scaling interface provides a data interface and a control interface among gateway modules. The data interface functionally extends buses 221, 222, 223, 224, and 214 outside one gateway module for use by one or more other gateway modules. Because these other gateway modules may provide redundancy and/or increased message processing capacity, the interface facilitates implementing a gateway to any scale (e.g., quantity of ports; mix of message processing rates; quantity of supervisors, gateway modules, and/or communication engines). The scaling interface 136 conveys timing signals and indications of whether timing signals are to be generated, regenerated, or simply used by other gateway modules. By providing timing signals, communication engines in different communication engines may operate concurrently, processing the same messages so as to be prepared for commissioning on failover.

A switchover circuit changes the coupling of a message stream and gateway services for a message stream from a current network facility to an alternate network facility. The change in coupling may be made at the point of coupling the gateway to the medium of the network; or at a point after any suitable highly reliable network interface circuitry (e.g., after line termination circuits, after line isolation or protection circuits, after a transmit/receive switch or circulator, or after a transceiver). Preferably, the change is made at the earliest convenient point and therefore exposes the message traffic to the least risk of undetected failure or information loss on failure. Conventional circuits may be used including mechanical relays and semiconductor switches.

Switchover circuit 206 may include a relay circuit for coupling the output of either of two communication engines to one T1 line. Some T1 frames may not be accurately transmitted (i.e., lost) due to mechanical relay contact bouncing. However, switchover circuit 206 completes the switching operation typically in less than 50 msec, limiting data loss to less than a duration likely to cause dropping of any call that relies on time slots in the lost frames.

Shared access circuits include any conventional circuits for coupling a gateway to a local area (or wide area) network. In one implementation, conventional circuits are used for ethernet protocols on conventional media (e.g., 100baseT links). Enabling one of two communication engines to output messages via shared access circuit 212 to network 104 may be accomplished without relays. In a preferred implementation, controls effective to enable only one engine for communication on network 104 are derived from signals on bus 214. The number of packets not properly transmitted may include one or two packets for each LAN connection of shared access circuit 212. In some cases, a message may be sent twice: once from each communication engine, for example, as a consequence of minor variation in output queue arbitration. For instance, in one implementation communication via bus 214 describes the current status of round robin arbitration of dequeueing from output queues occurring in each communication engine so that no more than one packet is lost from each of several output queues. In other implementations, transfer of commissioning is accomplished in less time than required (or typically necessary) to lose more than one packet from the same queue. In still other implementations, transfer is designed to occur in less time than a maximum time for any portion of network interface 205 (e.g., shared access circuits operate in less time than the slowest switchover circuit).

Gateway module 122 may, in other implementations, include any number of network interfaces 205 for performing gateway functions between two or more networks coupled via such network interfaces. Further, each network interface 205 may include shared access circuits and/or switchover circuits in any quantity or combination. For example, shared access circuit 212 may be replaced with a second switchover circuit similar to circuit 206; or switchover circuit 206 may be replaced with a second shared access circuit similar to circuit 212.

A communication engine, according to various aspects of the present invention, includes a scalable architecture for performing lower level and upper level software as discussed above in any mix of circuitry (e.g., logic, state machines, stored program processors, digital signal processors (DSPs), or application specific integrated circuits (ASICs)). Because redundancy is implemented at the unit of the communication engine (202, 204) in a gateway module, each communication engine need not provide redundant circuitry. In other words, multiple identical circuits may be used for meeting a suitable capacity design goal for the communication engine.

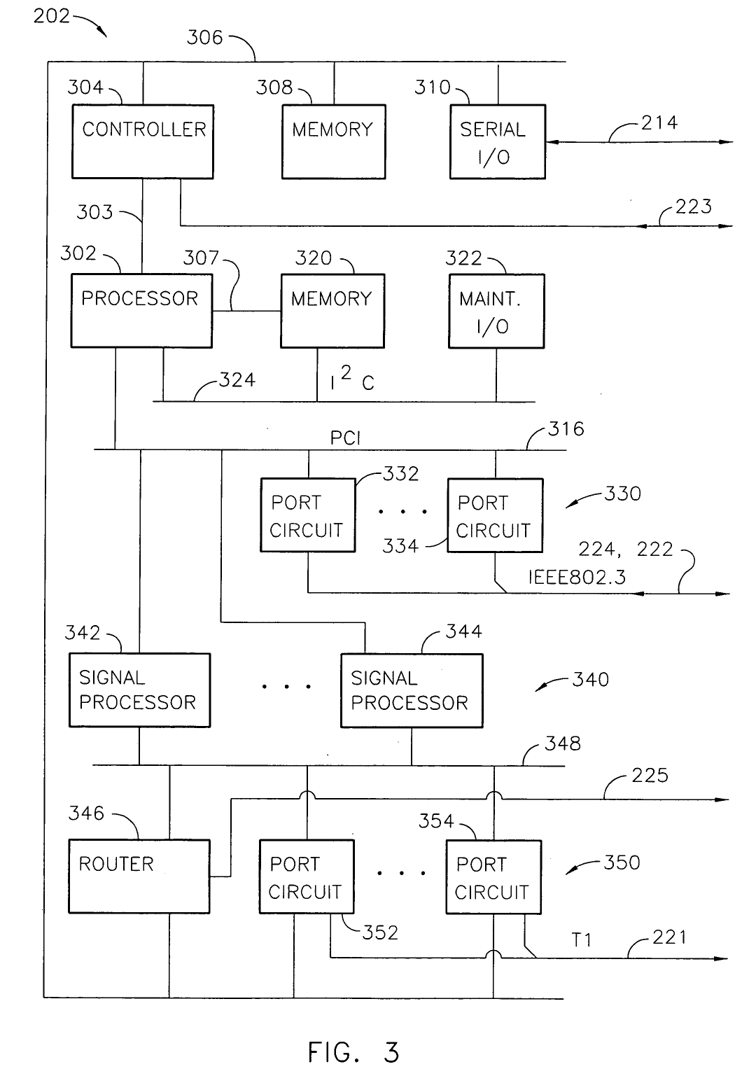

In one implementation, communication engine 202 includes the scalable architecture described in FIG. 3. Engine 202 of FIG. 3 includes processor 302 coupled by bus 303 to controller 304, bus 324, and bus 306. Engine 202 further includes memory 320 and maintenance I/O circuit 322 each having an I²C interface coupled to processor 302 by bus 324. Processor provides a conventional PCI bus 316 coupled to a set 330 of port circuits that facilitate communication via network 104 and to a set 340 of signal processors. A bus 348 couples signal processors of set 340, router 346, and a set 350 of port circuits that facilitate communication via network 102.

Processor 302 is coupled to memory 320 by bus 307 for operation as a general purpose processor (e.g., a communication software platform) for performing all lower level software and upper level software discussed above except for processes performed by dedicated processors and circuits discussed below. Processor 302 performs configuration control (e.g., setting the control registers to which dedicated processors and circuits operate) in response to monitoring conditions of the communication engine and its resources by maintenance I/O circuit 322 via bus 324. In one implementation, bus 324 is a conventional I²C bus.

Controller 304 cooperates with memory 308 as a stored program processor. Programs executed by controller 304 from memory 308 include an operating system (e.g., a real time and embedded version of Linux), a process for communication between engines 202 and 204 via serial input/output interface 310 and bus 214, a process for controlling routing, and a process for controlling port circuits 350. In an alternate implementation, processor 302 is replaced with a more capable processor, controller 304 is omitted, and processor 302 performs all of the aforementioned processes with suitable interfaces to the subordinate circuits discussed above.

A port circuit accomplishes the signal protocols for coupling to a network and may include message handling logic for some operations of one or more message protocols. Port circuits 332 and 334 of set 330, for example, send and receive signals in accordance with IEEE 802.3 on bus 222 discussed above. For increased message handling capability, port circuits perform any suitable operations prior to sending a message onto the network or following receiving a message from the network. Prior to sending a message, a port circuit may include queues and arbitrators for determining which message is next to be sent; and formatters for adding predefined portions to a message such as a header with source and destination addresses, indicia of message type, identification of the message to a dialog and/or session of messages, and information for traffic management (e.g., sequence number, QoS parameters). A port circuit may include a parser for message disassembly after receiving all or any portion of a message; error detection logic (e.g., for interrupting processor 302) and may include circuits for generating acknowledgement messages (in addition to acknowledgement signals of the signaling protocol), and messages requesting retransmission. When network 104 conveys conventional TCP and UDP packets, packets for voice telephony are conveyed by UDP packets and no request for retransmission is used.

Processor 302 reads input message queues filled by port circuits 330 receiving messages from network 104, determines message type by parsing a message header, routes messages of particular type(s) to the target identified as a destination in the message header, and prepares responses to messages of other types that make a request for information or command an action to be taken by engine 202. Input and/or output message queues may be maintained in port circuits 330. In an alternate implementation, input and/or output message queues are maintained in memory 320 linked in any conventional manner to port circuits 320 by direct memory access circuits.

Processor 302 also writes output message queues emptied by port circuits 330 sending messages onto network 104, formats messages, prepares message headers, and performs all suitable tasks to gather information to be included in a message (e.g., a response to a request for information). Processor 302 may of its own initiative prepare messages to be sent on network 104 and write these to message queues as discussed above. Processor 302 may make requests of other entities reachable by communication via networks 102 and 104. For example, processor 302 conducts discovery in a conventional manner, prepares routing tables, shares routing information with other communication engines and gateway modules, monitors link status reported by any port circuit (330 or 350), and reports changes in link status to supervisor 112 via supervisor interface 208.

Generally, a signal processor performs conversions on message payloads (content). Conversions include parsing and reformatting to convert messages between a frame-based protocol (e.g., TDM as on T1, E1, and J1 interfaces) and a packet-based protocol (e.g., ATM, UDP, TCP/IP). For example, signal processor 342 (typical of each signal processor in set 340) in any conventional manner prepares TCP/IP packets to send in response to received TDM frame contents; and prepares TDM frame contents to send in accordance with received TCP/IP packets. For example, for each voice telephony call having data in a series of time slots in T1 frames received by a port circuit (352) from network 102, the values from the time slots are: (a) reported to another port circuit of set 350 for sending in suitable time slots of any port circuit of set 350; and/or (b) grouped for inclusion in at least one packet by port circuit of set 330. Any signal processor may, at any suitable time, operate as a bus master of bus 316 to obtain packets from port circuits of set 330 and to provide packets to port circuits of set 330.

A router operates according to a map to provide a fabric over which any port circuit of set 350 may communicate with any other port circuit of set 350. In addition, a router moves values received from T1 time slots into signal processors of set 340 enroute to ports of set 330; and moves values received in packets from signal processors of set 340 enroute to ports of set 350.

For example, router 346 operates from a map stored by controller 304 in memory 308. Processor 302 may prepare the map as a result of network discovery, network logins, and related information and provide the map to controller 304. The map may include port circuit identifiers for ports to be used in a link supporting a call. The map may further include signal processor identifiers for protocol conversion on the link. For example, port circuit 332, signal processor 344, and port circuit 352 may be identified as a tuple for a particular link for one or more calls.

Router 346 also provides a bus 225 for coupling to the router portion of another communication engine (e.g., 204) of this or another gateway module (via scaling interface 210 and bus 142). Signals on bus 225 may include packet and time slot payload data from any message handled by communication engine 202.

As a consequence of the architecture discussed above, gateway 103 provides continuous communication services without significant loss of data and with extraordinary availability of communication links. Once a link is assigned to a call, the link may remain operating (i.e., available to the call) at a statistical average of 99.999% of all link utilization time. In other words, in the event of a failure on a link, the link will be maintained and the call will not be dropped in 99.999% of all calls on that link. There may be some data lost in transfer of link responsibility from a decommissioned communication engine to a newly commissioned communication engine, but the duration of link interruption for transfer of responsibility will not be so great as to result in dropping the call or adversely affecting the operation of application programs at the communication engine level or supervisor level.

According to various aspects of the present invention, transfer of link responsibility as discussed above does not substantially interrupt operation of any communication service performed by a gateway module or supervisor. As discussed above such services include message based services such as accurately accounting the duration of a call (e.g., conventional call duration billing) and/or accurately accounting the network utilization of a call (e.g., packet quantity, packet size, or quantity of data conveyed during a call).

To accomplish minimal interruption of communication services, each message (e.g., a packet or frame) received from either network is presented for processing by each communication engine of a gateway module. Each communication engine prepares output messages for each network whether or not the communication engine is currently commissioned. The commissioned communication engine output is suitably coupled to each network. Because both communication engines additionally monitor gateway module performance, either communication engine may determine that a detected failure warrants decommissioning of the currently commissioned communication processor and commissioning of the other communication engine. The newly commissioned communication engine (after perhaps a minor loss of data) continues to perform message handling services this time with output to networks 102 and 104; and, continues all other services (e.g., accounting services discussed above) without the need to develop an initial state from a default state or from a last known state of the decommissioned communication engine.

Controller 304 and processor 302 (and corresponding concurrently performed processes in engine 204) perform processes for monitoring physical and logical conditions of operation of gateway module 122, detecting exceptional conditions, classifying exceptional conditions as to whether a decommissioning/commissioning operation is desirable, and conducting or cooperating with a decommissioning/commissioning operation. Exceptional conditions (e.g., failures) sufficient for a decommissioning/commissioning operation as discussed above include: power supply temperature, output voltage, output current, or magnitude of output frequency components out of acceptable range; all conventional exceptional conditions of a T1 line, a LAN line (e.g., high latency), a port circuit (332 or 352), a router, or a signal processor; and all conventional exceptional conditions of a processor, a controller, a memory, a bus or an I/O interface (e.g., expiration of a local watchdog timer set by another entity on the bus or I/O interface). Load sharing and failover using conventional methods may be employed to assure that a sufficient quantity of supervisors (112) are operating without interruption of communication services related to gateway modules.

According to various aspects of the present invention, an identical suite of communication processes is performed independently and concurrently in each communication engine 202 and 204. For example, suite 400 includes call processing process 402, dequeueing processes 404 and 406, reconfiguring process 408, monitoring and diagnostic process 410, reporting process 412, voluntary release process 414, take over process 416, and exchange process 418. Processes in suite 400 are stored and executed from memory 308 and 320 in any suitable combination. Data used by any process of suite 400 is also stored in any suitable combination of memory 308 and 320. Data storage includes T1 input queues 432, LAN input queues 436, T1 output queues 434, LAN output queues 438, and statistics and settings store 440.

Processes of the suite may be performed in a multithreaded, multitasking environment, without regard, or with any conventional regard for priority of execution. Each process may be performed whenever sufficient data is available to the process. Each process may make suitable inquiry to determine whether sufficient data is available. In effect, all processes of the suite are being performed by each communication engine simultaneously and independently of the other communication processor. As discussed below, state differences between instances of corresponding processes in respective communication engines are substantially insignificant to operation of gateway 103 except, for example, the instances of dequeueing processes 404 and 406 in a commissioned engine perform differently than corresponding instances of dequeueing processes 404 and 406 in a decommissioned engine. Each process that has different operations based on whether or not the process is being performed on a commissioned or decommissioned engine regularly refers to settings 440 to verify the commissioned/decommissioned status of its host engine.

Each processor performs an operating system (not shown) and drivers (not shown) for circuits shown in FIG. 3. In particular, a driver (not shown) for port circuits 330 receives network messages and enqueues them respectively in T1 input queues 432, and LAN input queues 436. This driver in cooperation with port circuits also implements transmission of messages dequeued by processes 404 and 406. In alternate implementations, dequeueing processes 404 and 406 are implemented in any combination of the driver, the operating system, or port circuits 330 with a suitable interface to other processes of suite 400 (e.g., by maintaining status in statistics and settings store 440).

A call processing process manages the particular protocols suitable for communication between endpoints of each call. Conventional software for each protocol and for suitable call processing functions may be used. For example, call processing process 402 receives suitable respective notice of T1 input queue 432 contents and in response to input messages dequeued from queue 432 determines one or more output messages and posts these output messages in T1 output queues 434. Call processing process 402 receives suitable respective notice of LAN input queue 436 contents and in response to input messages dequeued from queue 436 determines one or more output messages and posts these output messages in LAN output queues 438.

For providing a respective quality of service for individual calls (or types of calls), one input queue and one output queue are implemented for each call (or type of call). Conventional arbitration techniques may be implemented for selecting a next message and a next input queue to be processed.

Call processing process 402 accumulates conventional statistics in any conventional manner and posts results in statistics and settings store 440. Conventional settings from store 402 affect operation of call processing process 402. For example, settings may describe the identity and capabilities of resources (e.g., port circuits 330 and 350, signal processors 340), identify and provide criteria for protocols, identify routes, and provide criteria for routing functions.

When operating on a commissioned communication engine, dequeueing process 404 removes messages posted to T1 output queues 434 and enables transmission of each dequeued message onto network 102 via bus 132, network interface 205, and a port circuit 350 and/or router 346. Otherwise, when operating on a decommissioned (i.e., a reserve) communication engine, dequeueing process 404 removes the message from queue 434 without enabling transmission of the message. Transmission may be disabled at any point in the physical path and logical from queue 434 to network 102. Preferably, the storage space in queue 434 once occupied by the message being dequeued is freed. In one implementation using a conventional ring buffer as a queue, pointers in queue 434 are moved and the storage space in queue 434 may be reused immediately for posting another message to queue 434. To facilitate suitably concurrent processing by the commissioned and decommissioned engines, dequeueing process 404 as performed by a decommissioned engine may allocate resources and/or impose delays to simulate the transmission of each discarded message.

When operating on a commissioned communication engine, dequeueing process 406 removes messages posted to LAN output queues 438 and enables transmission of each dequeued message onto network 104 via bus 134, network interface 205, and a port circuit 330 and/or router 346. Otherwise, when operating on a decommissioned (i.e., a reserve) communication engine, dequeueing process 406 removes the message from queue 438 without enabling transmission of the message. Transmission may be disabled at any point in the physical path and logical from queue 438 to network 104. Preferably, the storage space in queue 438 once occupied by the message being dequeued is freed. In one implementation using a conventional ring buffer as a queue, pointers in queue 438 are moved and the storage space in queue 438 may be reused immediately for posting another message to queue 438. To facilitate suitably concurrent processing by the commissioned and decommissioned engines, dequeueing process 406 as performed by a decommissioned engine may allocate resources and/or impose delays to simulate the transmission of each discarded message.

Each process 404 and 406 determines whether it is being performed by a commissioned or decommissioned engine with reference to settings store 440. In one implementation of settings 440, both communication engines 202 and 204 have access to 4 status bits to coordinate a decommissioning/conditioning operation. The 4 status bits form two dibits. Each dibit is written by one of the engines. Dibit values of 00 and 11 are considered invalid (e.g., an exceptional condition). Dibit values of 01 and 10 are considered valid. Combinations of valid dibit values have the meanings described in Table 1. In alternate implementations two copies of these 4 status bits are kept identical by exchange process 418.

TABLE 1

| Dibit Written | Dibit Written | |
|---|---|---|
| By Engine | By Engine | |
| 202 | 204 | Meaning |
| 01 | 01 | Engine 202 is currently commissioned and |
| | | engine 204 is currently decommissioned |
| 10 | 10 | same as the prior row |
| 01 | 10 | Engine 204 is currently commissioned and |
| | | engine 202 is currently decommissioned |
| 10 | 01 | same as the prior row |

A signal suitable for maintaining a call (e.g., for forcing link hardware not to retrain) may be introduced onto one or both networks 102 and 104 by network interface 205 prior to or during a decommissioning/commissioning operation.

In-band and/or out-of-band signaling may be used to convey configuration, provisioning, and reporting information to a communication engine. For example, in-band signaling from network 104 may provide information and/or messages in LAN input queues 436 distinguished for functions of reconfiguration, provisioning, and/or reporting.

A reconfiguring process receives reconfiguration information from network 102 and/or 104 and changes the values of settings in statistics and settings store 440 in any conventional manner. Reconfiguration may use a conventional protocol such as SNMP. For example, process 408 dequeues messages from LAN input queues 436, performs any suitable operations to validate the request to change communication engine settings, and if valid, adds, modifies, and/or deletes settings in store 440. Any conventional technique may be used to reduce the risk that settings as read by one engine (e.g., 202) differ from settings as read by another communication engine (e.g., 204). Alternatively, process 408 may read reconfiguration information from portions of messages according to a conventional robbed bit technique.

A monitoring and diagnostic process may passively determine whether software and circuit functions are exceptional or not, and/or actively exercise software and circuit functions for the same determination. Exceptional conditions may include any physical or logical condition conventionally considered exceptional including conditions evincing failure, an increased risk of failure, insufficient computing resources, and unsuitable conditions of any network link or endpoint of networks 102 and 104. Results of such determinations may be posted to statistics and settings store 440 and accessible to both communication engines 202 and 204. For example, process 410 may dynamically post individually or by RMS combination mean time between failure statistics of its own processing, memory, and interfacing resources.

A reporting process reports statistics and settings to an endpoint of either network 102 and/or 104. Reporting may be spontaneous or in response to request received on either network. Reporting may use a conventional protocol such as SNMP. For example, reporting process 412 dequeues messages from LAN input queues 436, performs any suitable operations to validate the request for a report, and if valid, prepares a suitable report and may post messages to LAN output queues 438 to transmit (or multicast or broadcast) the report to suitable endpoints. Prepared reports may be retained in memory pending a request for a report. Alternatively, process 412 may read requests for reports from portions of messages according to a conventional robbed bit technique. The transmission of a report is subject to dequeueing as discussed above to assure that only one version or copy of the report is transmitted. Because decommissioned engines prepare reports and enqueue messages regarding reports, reports of suitable accuracy and completeness are available regardless of release or take over operations.

A voluntary release process, operating in a commissioned communication engine initiates self decommissioning and commissioning of an alternate communication engine (also called initiating a release) to assure reliable operation of the gateway it is a part of. For example, voluntary release process 414 may initiate a release on notice of an exceptional condition (e.g., occurring on network 102, on network 104, or on its own communication engine), signals on bus 214, or as indicated in a portion of statistics and settings store 440 that is accessible to both communication engines.. Process 414 may compute a conventional figure of merit of its own processing, memory, and/or interfacing capabilities, compare its figure of merit to a similar figure of merit computed for the reserve engine, and in cases of a difference exceeding a threshold (e.g., to implement hysteresis) may initiate a release. Release may include process 414 storing suitable settings in store 440 as discussed above. A voluntary release process may continue to operate in a decommissioned communication engine because initiating a release of a decommissioned engine generally has no effect on gateway module operations.

A take over process operating in a decommissioned communication engine initiates self commissioning and decommissioning of an alternate communication engine (also called initiating a take over) to assure reliable operation of the gateway it is a part of. For example, take over process 416 may initiate a take over on notice of an exceptional condition (e.g., occurring on network 102, on network 104, or on the commissioned communication engine), signals on bus 214, or as indicated in a portion of statistics and settings store 440 that is accessible to both communication engines. Process 416 may compute a conventional figure of merit of its own processing, memory, and/or interfacing capabilities, compare its figure of merit to a similar figure of merit computed for the commissioned engine, and in cases of a difference exceeding a threshold (e.g., to implement hysteresis) may initiate a take over. Take over may include process 416 storing suitable settings in store 440 as discussed above. A take over process may continue to operate in a commissioned communication engine because initiating a take over by a commissioned engine generally has no effect on gateway module operations.

An exchange process performed by a first communication engine cooperates with an identical exchange process performed by a second communication engine to assure access to common information by multiple engines. Exchange processes may provide information in statistics and settings store 440 that is accessible to both engines (i.e., a common area), provide messages on bus 214 facilitating access to a common area, or provide messages on bus 214 comprising copies of information to assure that multiple instances of store 440 are effectively consistent (e.g., generally identical). Instances of exchange processes 418 in each engine may spontaneously report information; or, request and respond to requests for information. Information exchanged may include state information about any process of suite 400 including for example, depth of queues 432-438 and timestamps regarding instantiation of tasks or regarding configuration changes.

One or more supervisors 110 may perform a service for reporting the condition of the gateway in response to a request for such information. The request may arrive from either network 102 or 104, preferably network 104. For example, a request consistent with SNMP may request data in accordance with an MIB. A conventional simple network management protocol (SNMP) provides a widely used network monitoring and control protocol. Data are passed from SNMP agents which are hardware and/or software processes (e.g., included in reporting process 412) reporting activity in each network node (e.g., hub, router, bridge, gateway, or gateway module) to the workstation console (e.g., an endpoint set) used to oversee the network. The agents return information contained in a management information base (MIB) which is a data structure that defines what is obtainable from the network node and what can be controlled (e.g., enabled, disabled, selected, set, reset, or tuned). SNMP may include security and remote monitoring (e.g., RMON) via an RMON MIB. Remote monitoring may provide periodic feedback without requests originating from the SNMP console.

Alternatively, a report and/or request/response consistent with HTTP and HTML (or XML) may be used. Information reported includes information as described in Table 2.

TABLE 2

| Category | Description |
|---|---|
| Frame based | Values per telephone network standards (e.g., as issued by Telcordia |
| protocol | Technologies, Inc.) including errors, error rates, burst errors, line outages, |
| performance | alarms . . . |
| monitoring and | |
| link status | |
| Frame based | Billable events (e.g., duration and bandwidth consumed by completed calls) |
| protocol link | and use of links for nonbillable events (e.g., call attempts that do not succeed) |
| utilization | |
| Frame based | Provisioning of alarm limits, hysteresis, physical characteristics of a link, |
| protocol settings | functions of a primary rate ISDN controller (PRI) |
| Packet based | Values per packet network standards (e.g., as issued by Internet Engineering |
| protocol | Task Force) including jitter, latency, saturation, traffic statistics, and functions |
| performance | of a real time control protocol (RTCP)). |
| monitoring and | |
| link status | |
| Packet based | Values describing which protocol is being used, rate and duration of packets |
| protocol link | transmitted and received, number of retransmissions, metrics describing |
| utilization | quality of service |
| Packet based | Provisioning of alarm limits, hysteresis, physical characteristics of a link |
| protocol settings | |
| Gateway | Designating a commissioned communication engine, criteria for a release, |
| module settings | criteria for a take over |

According to various aspects of the present invention, criteria (e.g., for a release or a take over) may be specified as one or more parameter/limit-value pairs or as conditional expressions that evaluate to a binary result. Parameters may be designated by any SNMP address. Limit values may be specified as the value at, beyond, or below which the criteria is satisfied. The selection of whether the test is a, beyond, or below the limit may be implied by the parameter (e.g., maximum power supply temperature) or stated via another parameter value. Parameters may be designated from one or any combination of more than one of the rows of table 2. Any conventional expression syntax (e.g., a mark up language consistent with XML) may be conveyed according to a suitable storage or communication protocol to enable a communication engine to evaluate a desired criteria at a time or periodicity as specified or implied by other criteria.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

1. A gateway module for use in a scalable gateway coupled to a provided network, the gateway module comprising:
a commissioned communication engine and a reserve communication engine that each facilitate voice communication between any two or more network ports of a plurality of network ports, the network ports comprising a first set operative in accordance with a first protocol and a second set operative in accordance with a second protocol different from the first protocol, each communication engine comprising for each port an input queue that receives network traffic and an output queue, each engine enqueueing into each output queue messages prepared in accordance with dequeueing from the respective input queue, each engine dequeueing from each output queue in accordance with the respective protocol;
a switchover circuit that couples data dequeued from each output queue of the commissioned communication engine to the provided network and, in response to either communication engine detecting an exceptional condition, decommissions the formerly commissioned communication engine and commissions the formerly reserve communication engine, wherein decommissioning comprises disabling the coupling to the provided network of data dequeued from the output queues of the formerly commissioned communication engine without disabling dequeueing from each output queue of the decommissioned engine; and
a scaling circuit that determines whether the gateway module is a provider of expansion signals; wherein if so, each communication engine and an interface of the gateway module are coupled to the scaling circuit to receive the expansion signals as provided by the scaling circuit; and if not, each communication engine is coupled to an interface of the gateway module to receive expansion signals as provided by a provided other gateway module; the expansion signals facilitating an expansion of the plurality of network ports to include network ports of the provided other gateway module.

2. The gateway module of claim 1 wherein:
the commissioned and the reserve communication engines each comprise a processor that performs a respective application program in accordance with the received network traffic; and
the commissioned and the reserve communication engines each enqueue a respective message in a respective output queue in accordance with a result of the respective application program.

3. The gateway module of claim 2 wherein each communication processor further comprises an operating system and an application program interface that presents a nonphysical model of the plurality of network ports to the application program.

4. The gateway module of claim 2 wherein the application program has access to an identifier and a status of a voice communication facilitated by its host communication engine.

5. The gateway module of claim 1 wherein the communication engines are coupled to each other for the exchange of at least one of indicia of completed tasks and indicia of queue contents so that the reserve communication engine on being commissioned may perform tasks or dequeueing not yet completed by the formerly commissioned communication engine.

6. The gateway module of claim 1 wherein each communication engine further comprises:
a first bus;
a plurality of port circuits, coupled to the first bus, for servicing network ports of the first set;
a plurality of signal processors, coupled to the first bus, for converting signals of the frame-based protocol to signals of the packet-based protocol; and
a router coupled to the bus and to the scaling interface, the router for managing communication among the signal processors, the network ports of the first set, and a corresponding router of the provided other gateway module coupled to the scaling interface.

7. The gateway module of claim 6 wherein each communication engine further comprises:
a second bus; and
a plurality of port circuits, coupled to the second bus, for servicing network ports of the second set; wherein:
the plurality of signal processors is further coupled to the second bus for converting signals of the packet-based protocol to signals of the frame-based protocol.

8. A gateway comprising:
a plurality of gateway modules according to claim 1;
a supervisor coupled to each communication engine of each gateway module of the plurality of gateway modules; and
means for coupling together the scaling interfaces of the gateway modules of the plurality of gateway modules.

9. A gateway comprising:
a plurality of gateway modules according to claim 2;
a supervisor coupled to each communication engine of each gateway module of the plurality of gateway modules; and
means for coupling together the scaling interfaces of the gateway modules of the plurality of gateway modules, wherein
the supervisor prepares billing information in response to respective results provided by application programs.

10. A gateway comprising:
a plurality of gateway modules according to claim 2;
a supervisor coupled to each communication engine of each gateway module of the plurality of gateway modules; and
means for coupling together the scaling interfaces of the gateway modules of the plurality of gateway modules, wherein the supervisor designates an alternate endpoint in response to respective results provided by application programs.

11. A management information base for managing a gateway, the base comprising:
a first plurality of parameters consistent with a standard as applied to a frame-based network node; and
a second plurality of parameters consistent with a standard as applied to a packet-based network node.

12. The management information base of claim 11 further comprising criteria for decommissioning a communication engine of the gateway wherein the criteria include an expression referring to a parameter of the first plurality and to a parameter of the second plurality.
